(19) United States
(12) Patent Application Publication
(10) Pub. No.: US 2021/0323226 A1
(43) Pub. Date: Oct. 21, 2021

(54) Methods and Materials for Creating Three-Dimensional Objects within a Fluidized Bed

(71) Applicant: George Edward Parris, Gaithersburg, MD (US)

(72) Inventor: George Edward Parris, Gaithersburg, MD (US)

(21) Appl. No.: 17/321,406

(22) Filed: May 15, 2021

Related U.S. Application Data
(63) Continuation-in-part of application No. 15/927,407, filed on Mar. 21, 2018.
Application No. 15/927,407 is a continuation-in-part of application No. 16/350,502, filed on Nov. 26, 2018.
(60) Provisional application No. 63/070,191, filed on Aug. 25, 2020.
(60) Provisional application No. 62/547,963, filed on Aug. 21, 2017.
(60) Provisional application No. 62/547,963, filed on Aug. 21, 2017.

(51) Int. Cl. B29C 64/153; B29C 64/371; B29C 64/321; B29C 64/268; B22F 10/20; B22F 12/41; B22F 12/70; B22F 12/50; B33Y 10/00; B33Y 40/00; B33Y 70/00

(52) U.S. Cl. CPC B29C 64/153; B22F 2301/35; B29C 64/321; B29C 64/268; B22F 10/20; B22F 12/41; B22F 12/70; B22F 12/50; B33Y 10/00; B33Y 40/00; B33Y 70/00; B22F 2202/15; B22F 2201/013; B22F 2201/10; B22F 2302/256; B29C 64/371

(57) ABSTRACT

This disclosure concerns building of three-dimensional objects in a fluidized bed of particles. The invention uses the fluidized bed as a medium for building three-dimensional objects by joining individual particles together in a planned pattern to fabricate a product. The fluid-like properties of the fluidized bed permit movement of computer-controlled, mechanically driven probes through the fluidized medium. The probes deliver adhesives or energy to specific points in the fluidized bed. The adhesives bind the particles together. Energy delivered by the probes causes fusion and welding or chemical bonding of the particles. The invention encompasses any shape, size, or composition of particles. Particles may be joined but not limited to adhesion, welding, and chemical bonding. Auxiliary features include use of stationary or mobile forms, changing the pattern of fluidization, use of multiple probes working simultaneously, and introduction of solid objects into the build, etc., to assist in forming the product.

### CROSS-REFERENCE TO RELATED APPLICATIONS

This application is a continuation in part of pending U.S. application Ser. No. 15/927,407 filed Mar. 21, 2018 and Ser. No. 16/350,502 filed Nov. 26, 2018. This application claims benefit of pending U.S. Provisional Application No. 63/070,191 filed on Aug. 25, 2020. This application also claims benefit to currently pending U.S. Nonprovisional application Ser. No. 15/927,407 filed Mar. 21, 2018, expired Provisional Application 62/547,963 filed on Aug. 21, 2017, and pending application Ser. No. 16/350,502. Application Ser. Nos. 15/927,407 and 16/350,502 claimed benefit of the filing date of 62/547,963. The contents of application 63/070,191, Ser. Nos. 15/927,407, 15/927,407, and 62/547,963 are hereby incorporated by reference in their entirety.

### BACKGROUND OF THE INVENTION

### Field of the Invention

The present invention relates generally to the field of additive manufacture wherein three-dimensional parts are fabricated.

### Description of Related Art Including Information Disclosed Under 37 CFR 1.97 and 1.98

Three-dimensional printing using a filament of thermoplastic or metal is well known. According to conventional methods, a fusible filament is fed into a printer head where it is fused and welded to an existing surface. Objects produced by conventional three-dimensional printing are formed layer by layer from the bottom up. Continuous three-dimensional printing methods have also been described. An ultraviolet source is projected through a window and through a thin layer of unreactive liquid (created by dense fluid or penetration of a quenching agent (e.g., oxygen) through the window) to produce a layered object in two-dimensional slices simultaneously. Continuous three-dimensional printing is faster because an entire layer is formed at once. It is more common for three-dimensional printing of metal parts to employ a thin stationary bed of very fine metallic particles that are typically fused together with a high-power laser. Then a new layer of metal powder is mechanically spread over the first layer so that the process can be repeated. The process of continuous three-dimensional printing is also completed from the bottom up but is a laborious process which requires adding one thin layer of metal powder at a time.

### BRIEF SUMMARY OF THE INVENTION

Methods and materials are disclosed for building three-dimensional objects in which the objects are formed through polymerization of resins or monomers, or fusion of solids. Three-dimensional objects are built from one or more attachment points fixed within a fluidized bed. One or more mechanically driven computer-controlled probes emit heat, adhesive fluid, electromagnetic radiation, charged particles, or sound waves. The probes extend into and move through the fluidized bed of particles of the desired material and provide energy to the medium to initiate reaction or cause fusion. According to the instant invention, the process is referred to as three-dimensional building with the product usually called a build.

The term “particle” is used in this application to include solids, viscous liquids or liquid droplets of any shape (including filaments and sheets), composition or size as long as they can be fluidized.

The fluidized bed of material, may be fluidized by the flow of gases, liquids or super-critical fluids or by vibrations (e.g., sound waves). The flow of fluids, vibrations or sound waves, may be modulated to assist in the formation of the desired pattern joining the particles. The fluidizing fluid may be inert (e.g., perfluoro alkane or argon) or reactive (i.e., take part in the reaction that joins the particles). For example, hydrogen gas may be used to fluidized a metal oxide and take part in the reduction of the metal oxide to the metal.

The chamber in which the build is performed, may be any shape or size and may have supplemental baffles or stirring devices as appropriate.

The probes may be designed to concentrate their effect at a small point, along a linear line, or on a surface. Heat may be delivered to the fluidized bed by a probe that creates a flame (such as an oxy/acetylene torch) or electromagnetic induction or resistance heating. A conventional three-dimensional printing head that is heated and extrudes a fused plastic or metal may be used within the fluidized bed. In this case, the conventional printing head is delivering the fused plastic or metal as an adhesive. Importantly, the conventional head is not constrained to move in a single plane within the fluidized bed.

To deliver electromagnetic radiation within the fluidized bed, a heated probe or a probe made from optical fiber is employed. To deliver charged particles (electrons) a high-voltage electrode is provided to the probe. To prevent adhesion of the reacting materials to the emission source (e.g., optical fiber, heated element or electrode), the emitting surface of the probe is flushed with light-transmitting gas or liquid, which either prevents polymerization or fusion of the reaction mixture on the probe or immediately sheds it into the stream of fluidizing material. Candidate probe-flushing substances include perfluoroalkanes with or without dissolved oxygen, water, and inert gases such as argon.

The probe may also directly deliver an adhesive material that is activated upon contact with the suspended solids or the fluid that fluidized the solid particles. The adhesive may be released continuously or in short burst at the points where it is desired. In some cases, the adhesive may replace the purging fluid in the probe and be activated as it leaves the probe by ultraviolet light or heat provided by the probe.

### BRIEF DESCRIPTION OF THE SEVERAL VIEWS OF THE DRAWING(S)

FIG. 1. General arrangements for three-dimensional building in a fluidized bed.

FIG. 2. General structure of a probe to deliver energy or activated adhesive within a fluidized bed.

FIG. 3. General structure of a probe to deliver adhesive to the solids within a fluidized bed.

FIG. 4. Examples showing that the emitting end or orifice of probes can be any size or shape including points, lines, or sheets. The details of the edges of the emitting end or orifice can also be any size or shape (e.g., the emitting end or orifice can be constricted, tapered, a slit, multiple slits, hexagonal, star-shaped or combinations)

### INDEX OF ELEMENTS IN THE DRAWINGS

1. Fluidized bed
2. particles 2 (fluidized)
3. Probe(s)
4. Inflowing fluidizing medium
5. Outflowing fluidizing medium
6. Product
7. Attachment support
12. Adhesive
13. Cavity
14. Fluidized solid
15 emitting end of the probe
16. Straight probe
17. Right angle probe
18 obtuse angle probe
19. Acute angle probe
20. Linear probe
21. Entry port
22. Slot
23. Electromagnetic radiation
24. Activating zone
25. Optical fiber
26. Wall
27. Conduit
28. Surface
29. First space
30. Second space

### DETAILED DESCRIPTION OF THE INVENTION

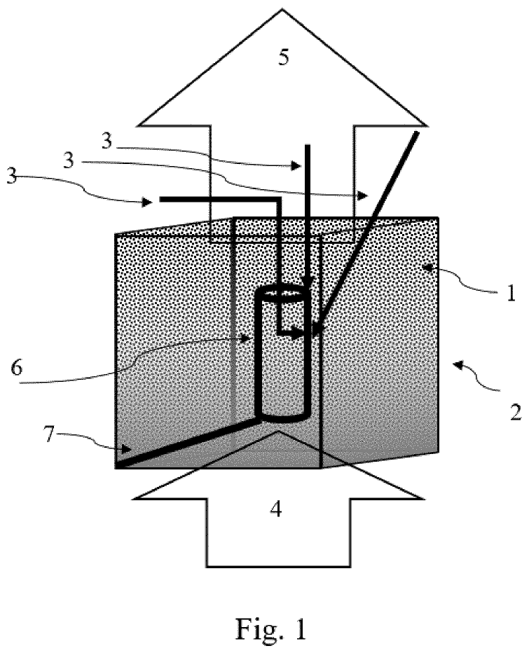

One aspect of the invention FIG. 1 is to provide a fluidized bed 1 of reactive, bondable or fusible particles 2 of any size shape or composition. Mechanically driven, computer-controlled probes 3 can move freely within the fluidized bed to deliver adhesives or energy to cause adhesion—through reaction or fusion—of the particles in a selected pattern within the fluidizing medium, which enters the container as inflowing fluidizing medium 4 and exits the container as outflowing medium 5. The particles may be fluidized by a flow of gas, liquid or supercritical fluid, by magnetic fields (acting on ferromagnetic particles), by electric fields (acting on charged particles), or by vibrations, including sound waves. In zero-gravity or in emulsions of liquids, the particles may be held apart by electrostatic forces alone.

The mobile reaction mixture may include particles of reactive or fusible organic monomer or resin, or inert material coated with a reactive or fusible monomer or resin. The suspended (fluidized) material that is being formed into a three-dimensional solid product 6 may be completely inert or may be reactive or fusible. In most cases, the particles will be homogenous, but they may have a heterogeneous chemical composition, such as layers of different materials. In most cases, the particles in a fluidized bed will be of the same type; but within a single fluidized bed, they may vary in size, shape or composition. The composition of the fluidized material may be varied during the build.

Inert objects, such as wires, rods, tubes, threaded rods, sheets, filaments, molds, or electrical or mechanical components, may be introduced into the fluidized bed before or during fluidization to assist in forming the product or to become part of the final product. Unlike the fluidized particles that move randomly, the positions of these objects will normally be fixed relative to the coordinate system of the reaction vessel or move in coordination with the probes.

One or more computer-controlled probes 3 are mechanically moved in three dimensions through the mobile reaction mixture (i.e., fluidized bed) and energized in a predetermined pattern to initiate adhesion, reaction or fusion of the monomer or resin to form a solid or semi-solid product. The product may be metallic, organic polymer, elemental carbon, or inorganic polymer or combinations of these.

Reactive monomers may be part of the fluidized particles or may be part of the fluidizing medium (liquid, gas or supercritical fluid) or delivered from the probes. Reactive monomers, may include (i) isomers of dichloroethane, trichlorobenzene or hexachlorocyclohexane (all of which have an empirical formula “CHCl”) or any carbohydrate with a formula “CH₂O”; (ii) organic oligomers or resins; (iii) monomers that decompose to metals or metalloids, including metal carbonyls (e.g., Ni(CO)₄), metal alkanes (Al₂(CH₃)₆), metalloid alkanes (e.g., As(CH₃)₃), and metalloid hydrides (e.g., B₂H₆, SiH₄, or AsH₃); (iv) hydrogen gas (H₂) or other gases that may reduce metal salts or oxides to metals; (v) inert materials (such as particles or fibers of silica or carbon) coated with reactive monomers or resins. The reactive monomers may be pre-coated onto the solids or may be all or part of the fluidizing medium or may be delivered via the probe.

Conventionally, an upward flow (against gravity) of fluid (gas, liquid or supercritical fluid) has been used to achieve a uniform suspension of mobile particles. This invention anticipates that there may be situations in which only a selected portion of the reacting medium needs to fluidized at any particular time and the degree of particle separation may be varied as desired. Thus, the flow of fluids from below (or the sides) into the reaction mixture may be varied in space and time. Computer-controlled, mechanically-driven probes delivering fluidizing media may also be employed within the fluidized beds. It is also anticipated that some solid particulate materials of interest may be less dense than the desired fluidizing media. For example, polyethylene has a density of only 0.96 g/cc and water (H₂O) has a density of 1.00 g/cc such that a reverse fluidized bed (downward flow) would be appropriate.

In addition, the invention anticipates the use of vibration of particle to suspend them in vacuum or fluid. The vibration (e.g., sound waves) may be of any frequency or amplitude. The vibrations may be used in conjunction with a flow of fluid or independently. Importantly, the vibrations can be constructed from the interference of simultaneous sound waves from various directions with various frequencies and various amplitudes. These converging sound waves will form a pattern of motion within the fluidized medium, which can be used to assist or control the formation of a product. Fourier and Laplace transforms can be used to design three-dimensional fields of sound waves to assist in forming the desired pattern.

These patterns of sound and fluid flow may be coordinated with the motion of the probes to optimize the creation of the desired pattern in the fluidized bed. For example, as the desired pattern is being built, fluidization may be briefly stopped (interrupted) once the probe is in the correct position to facilitate efficient and precise joining of the particles.

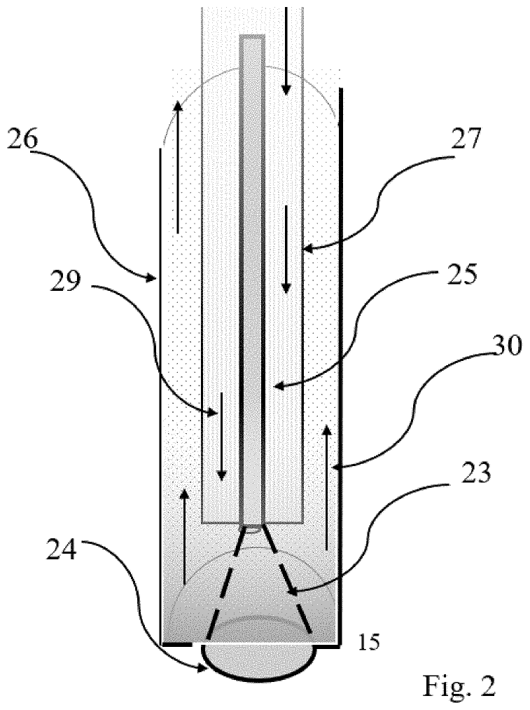

FIG. 2 illustrates a probe to deliver electromagnetic radiation. A beam of electromagnetic radiation 23 is emitted from an emitting end 15 which illuminates an activating zone 24. The electromagnetic radiation is conducted through optical fiber 25, which is coaxial with the cylindrical probe, the probe having a wall 26 forming it's outer boundary. A conduit 27 having a surface 28 surrounds the optical fiber. A first space 29 between the surface of the conduit and the optical fiber directs a transparent inert gas from the end opposite the emitting end toward the emitting end with the gas returning toward the opposite end through a second space 30 between the surface of the conduit and the wall of the probe. The flow of inert gas prevents the particles from sticking to the probe and occluding the beam of electromagnetic radiation. The gas can also cool the probe.

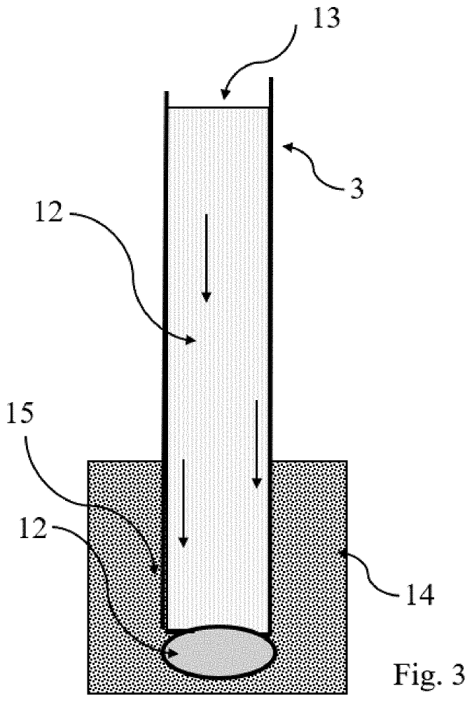

A probe 3 configured to deliver an adhesive is shown in FIG. 3. Adhesive 12 within the cavity 13 of the probe is directed to a fluidized solid 14 at an emitting end 15 of the probe.

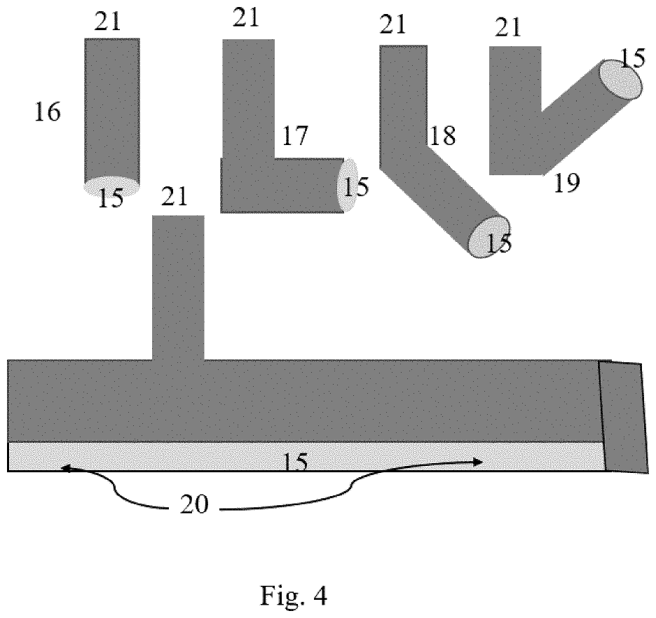

FIG. 4 illustrates that probes can be of any size or shape. Five probes for delivering a bonding agent or adhesive are shown. straight 16, right angle 17, obtuse angle 18, acute angle 19, and linear 20. Bonding agent enters the probe through entry port 21 and exits through slot 22 or through an emitting end 15.

### EXAMPLES

The use of a fluidized bed as a stage for additive fabrication is a novel method with numerous embodiments. Conceptually, the fluidized particles are being brought together to form a solid three-dimensional pattern. The nature of (i) the particles (size, shape and composition); (ii) the fluidizing medium (gas, liquid, supercritical fluid) and mode of operation (speed, pressure, homogeneity), (iii) the method of forming the build pattern (probes, sound, supports); and (iv) the design and operation of the probes (energy source, adhesive source) are all features that can be varied. The following examples describe several embodiments of the invention.

### Example 1

A container equipped with a source of inert gas and a diffuser to release essentially homogeneous flow of the gas against the force of gravity is filled with small chips of a thermoplastic that are relatively homogeneous in size, shape and composition (FIG. 1). Application of the upward flow of gas is used to cause fluidization of the particles of plastic. A computer-controlled, mechanically-driven probe (FIG. 2) capable of intermittently releasing a powerful beam of infrared radiation absorbable by the plastic particles is inserted into the bed of fluidized particles. Starting from a fixed attachment support 7 (also referred to as an attachment point) (FIG. 1) in the fluidized bed, the probe applies burst of energy capable of melting the surface of the particles and causing them to fuse to the attachment point. Working from this point, energy releases from the probe progressively add particles to the mass to grow a selected pattern in three-dimensions. Once the pattern has been completed, the probe is removed and the unaltered particles of plastic are separated from the fused pattern of plastic particles, which comprise some product. This product may be the finished item or it may be post-treated by fusing/annealing, application of coating layers, sanding, milling or any other finishing steps.

This process can be modified in many ways including but not limited to (i) using multiple probes at the same time; (ii) using different fluidizing fluid; (iii) fluidizing with vibrations; (iv) using sound waves to create patterns in the fluidized bed; (v) applying varying or asymmetric flows of the fluidizing fluid to control the pattern or facilitate positioning of the probe and the plastic particles; (vi) building the pattern in such a way to incorporate pre-formed and anchored solid objects such as wires, smooth rods, threaded rods, tubes, electrical or mechanical components.

### Example 2

A system is set up as in Example 1, but using a reactive plastic resin or particles coated with a reactive resin and a probe 8 that emits UV light that causes the resin particles to bond to one another.

### Example 3

A system is set up as in Example 1, but using a probe that releases and adhesive that causes the plastic particles to bond to one another.

### Example 4

A system is set up as in Example 1, but the solid particles are iron, steel alloys or other metals. The fluidizing gas is inert and the probe is an electrode designed basically the same as a plasma arc welding system. The build process proceeds much like plasma arc welding in three dimensions. Iron pentacarbonyl, nickel tetracarbonyl or other volatile may be added to the fluidizing gas if desired to modulate the composition of the alloy. Note that the path of least electrical resistance will be from the probe to the completed build even when the build particles are conductive because of the spaces among the particles filled with non-conducting fluidizing media.

### Example 5

A system is set up as in Example 1, but with metallic particles of iron and passing a fluidizing gas containing 1,1-dichloroethane through the bed and using a UV emitting probe. The UV radiation will cause the polymerization of 1,1-dichloroethane entrapping the iron particles to form the desired pattern. After the build, the unreacted iron particles are separated from the poly-C2H2Cl2 encapsulating iron particles. The polymer is then heated decomposing the polymer to carbon and HCl. The carbon and iron alloy to make steel.

### Example 6

A system is set up as in Example 5, but the solid particles are iron, the fluidizing gas includes iron pentacarbonyl and the probe emits infrared heat capable of decomposing the iron pentacarbonyl.

### Example 7

A fluidized bed of a viscous, polar, liquid resin is formed in an inert, nonpolar fluid such that the reaction mixture behaves as an emulsion (i.e., the liquid particles do not coagulate or settle rapidly when the flow of the fluid approaches zero). The term, polar, refers to non-uniform electrical charge or magnetic moment of a molecule or particle such that it will tend to align in an applied electrical or magnetic field. However, sound waves allow the resin particles to make contact in areas where the sound wave amplitude is high. Sound is a well-known method of breaking emulsions. Carlos Mario et al, Water-in-oil emulsions separation using an ultrasonic standing wave coalescence chamber. ULTRASONICS SONOCHEMISTRY v57 pp 57-61 (October 2019). Probes are inserted to initiate reaction into the regions where particle coalescence is directed by the standing wave. Regardless of the definitions of the terms polar and non-polar, it should be understood that any combination of polymerizable resin particles and solvent wherein an effective potential exists, that accounts for interactions between the solvent molecules and the particle and between the particles themselves, such that formation of colloidal suspensions are formed, is suitable for building three-dimensional objects according to the teachings of this disclosure. Thus, a combination of ‘polar’ resin and ‘nonpolar’ substance refers to refers to a combination wherein the molecules of the ‘polar’ resin have greater magnetic moment or charge displacement than the ‘nonpolar’ substance such that an effective potential exists, that accounts for interactions between the solvent molecules and the particle and between the particles themselves, such that formation of colloidal suspensions are formed.

### Example 8

Concurrent with the formation of the build (as described in Examples 1-7) by the action of the probe(s), auxiliary objects may be introduced into the fluidized bed transiently or permanently in fixed positions to assist in the build. For example, a polyfluoroalkane-coated metal plate may be introduced in such a way as to insure alignment of a surface of the build. A threaded rod may be introduced to act as a form for forming a threaded cavity in the build. A mechanical or electrical component may be introduced and held in place while the probes encapsulate it in the build. An object made of a low melting solid (e.g., wax) may be introduced to allow a cavity to be formed in the final build by melting and removing the low-melting material (the “lost wax” method).

### Example 9

A probe designed to produce a high-temperature flame (e.g., an oxy-acetylene torch with inert diluent gas if desired to moderate the flame temperature) may be used to fuse pure silica (SiO₂) or glass-forming mixtures of metal and non-metal oxides (e.g., borosilicate glass formulations) to make objects of glass.

### Example 10

A probe as described in Example 9, may be used in a bed fluidized by hydrogen gas (H₂) with or without inert diluent gases (e.g., argon) to reduce metal oxides to the fusible metals. An examples would be the formation of titanium-nickel alloys from the following reaction: TiO₂+3 metal+H₂→Ti-3 metal alloy+H₂O when the metal is typically in the nickel or cobalt family. Sekimoto et al, Reduction of Titanium Oxide to Titanium Alloy by Hydrogen, THE 3RD WORKSHOP ON REACTIVE METAL PROCESSING, Mar. 2-3, 2007, MIT, Cambridge, Mass.

### Example 11

After producing a build in the fluidized bed by any method involving forming a solid pattern from the fluidized particles additional finishing steps may be applied while in the fluidized bed.

The term, ultraviolet or UV refers to electromagnetic radiation with wavelength no longer than that ox X-rays but not longer than 350 nm. Visible refers to electromagnetic radiation with wavelengths between 350 and 700 nm with photons which can cause excitation of chemical bonds especially in visual pigment molecules that function in human vision.

Infrared or IR is comprises electromagnetic radiation with wavelengths longer than 700 nm but shorter than microwave wavelength.

Electromagnetic radiation is distinguished from ion beams because ions have mass and cannot travel at the speed of light. The interaction of high kinetic energy ions (e.g., proton beams) with matter is governed by the Bragg Principle whereby loss of kinetic energy is greatly accelerated as the speed of the ion particle decreased into the range of kinetic motion of the surrounding medium. This causes a distinct peak (Bragg Peak) in the linear energy density delivered by the particle beam.

Microwave refers to electromagnetic waves of microwave radiation having wavelengths longer than 1000 nm but shorter than radio waves.

The term, metal, refers to elements that, under ambient conditions, typically favor the allotropic form known as “metallic” which is characterized by free electrons that conduct electricity and heat in any direction, metals typically are malleable (easily deformed without breaking into fragments). Metals generally do not form covalent bonds with themselves or other metals, but may form covalent bonds with non-metals and metalloids. Metals include elements of the periodic table from group 1, and include elements from groups 2, 3-8, and 9-16 (excluding B, Si, Ge, As, Sb, Te, C, N, P, O, S, and Se).

Non-metals includes those elements that typically either do not form bonds (the noble gases of group 18) or favor allotropes involving covalent bonds. In particular, hydrogen, oxygen, nitrogen, fluorine, chlorine, bromine and iodine preferentially form diatomic molecules at ambient conditions. Phosphorus, sulfur and selenium form specific multiatom molecules (e.g., P4 and S₈) as well as polymers at ambient conditions. Carbon forms a wide variety of covalent compounds.

Metalloids refer to elements that routinely from covalent bonds (especially with carbon or hydrogen) but display metallic properties in the pure state. In the periodic table these typically form a zone between the true metals and the true nonmetals. They include boron, silicon, germanium, arsenic, antimony, tellurium, and astatine.

Families (of elements) refer to the elements in the same vertical column in the periodic table. Families of elements typically have similar chemical and physical properties varying in degree more than in kind. Some element families are given general names (halogens, inert or noble gases, alkali metals.)

Nonconducting materials refers to substances that inherently do not conduct electricity or heat well, because of their chemical properties. These include materials that do not have free electrons under ambient conditions (0-100° C. and 0.5-1.5 atm). Nonconducting materials would not include conductors such as metals and certain forms of carbon, including graphite and other forms. Examples of carbon conductors are described by Cesano et al, All-Carbon Conductors for Electronic and Electrical Wiring Applications, FRONT. MATER., 3 Sep. 2020, https://doi.org/10.3389/fmats.2020.00219.

A fluidized bed would be considered non-conducting media, even when a fluidized bed is composed of particles that are individually electrically conducting (e.g., metals). Macroscopic conduction through the bed is poor because the particles are constantly randomly separated from one another by a non-conducting media, such as an inert gas.

Fusible metal refers to any metal that can be melted using the heat achievable by the probes described in this application. Tin, copper, lead, aluminum, cadmium, indium and bismuth are easily fusible (low melting points) but iron and titanium are much higher melting and would require specific designs of probes (e.g., arc welding, acetylene welding, induction heating, and pulsed lasers) to be fused together. Particularly fusible metals according to the methods herein generally have melting points below about 200° C. and would be particularly useful, but, as noted above with specifically designed probes, an upper limit would be about 1000° C.

Inert gas as used here (fluidized bed) refers to any gas that is used in fluidizing the bed of particles that is chemically unreactive in the process used to join the particles. This included both the inherently inert elements (He, Ne, Ar, Kr, Xe, and Rn) and gases such as molecular nitrogen (N₂) that have low propensity to react. Nitrogen of course is much more economical to use than He, Ne or Ar and is able to substitute in many situations.

Low melting solid would include alloys, inorganic glasses, or plastic materials (e.g., polyethylene) that can be melted (fused) without decomposition typically between 100° C. and 500° C. Such materials may be applied as thin coats on higher melting particles to act as easily (heat) activated adhesives to form a three-dimensional build, which may be further annealed to melt the higher-melting cores of the particles. For example, fine titanium shot may be thinly coated with a lower melting metal that does not alloy with titanium. The coated shot could be formed into a rigid object in the fluidized bed (as described in the patent) and then transferred into a supporting ceramic powder and annealed to a temperature where the lower melting metal separates and the titanium is fused into a solid piece.

The term, solid pattern, in the context of the methods described herein, refers to a de novo generated pattern that is formed in three dimensions. A pattern, in this context, has a specific or characteristic shape that is not exclusively determined by the surface on which or medium in which it is created.

What is claimed is:

1. A method for building three dimensional objects comprising,
suspending particles to form a fluidized bed within a container, wherein said particles are,
suspended by a fluidizing medium, or
suspended by vibrations, or
suspended by applying an electric charge, or
suspended in a weightless environment,
moving a probe, starting at a fixed point within the fluidized bed, wherein movement of the probes is controlled by a computer,
applying a building agent to said fluidized particles for a period of time, said building agent being applied by said probe, wherein timing of said applying a building agent is controlled by said computer, and further wherein said building agent being applied in a three-dimensional pattern,
said building agent comprised of either electromagnetic radiation, flame, plasma arc, adhesive, or a chemical initiator.

2. The method of claim 1 further comprising wherein,
the forming fluidized particles step further comprising wherein the fluidized particles are comprised of a thermoplastic material or the fluidized particles are comprised of a non-thermoplastic material, wherein the non-thermoplastic material being coated with a thermoplastic material,
the forming fluidized particles step further comprising wherein the fluidizing medium is comprised of an inert gas, and
the applying a building agent step further comprising applying of infrared radiation.

3. The method of claim 1 further comprising wherein,
the forming fluidized particles step further comprising wherein the fluidized particles are comprised of a plastic resin or the fluidized particles having a plastic resin coating,
the forming fluidized particles step further comprising wherein the fluidizing medium is comprised of an inert gas, and
the applying a building agent step further comprising applying of ultraviolet radiation.

4. The method of claim 1 further comprising wherein,
the forming fluidized particles step further comprising wherein the fluidized particles are comprised of a plastic material,
the forming fluidized particles step further comprising wherein the fluidizing medium is comprised of a gas, and
the applying a building agent step further comprising applying of an adhesive.

5. The method of claim 1 further comprising wherein,
the forming fluidized particles step further comprising wherein the fluidized particles are comprised of a metal or a metal alloy,
the forming fluidized particles step further comprising wherein the fluidizing medium is comprised of an inert gas, and
the applying a building agent step further comprising wherein the building agent is,
(a) a plasma arc, or
(b) an electric arc, or
(c) oxy-fuel welding, or
(d) a laser.

6. The method of claim 1 further comprising wherein,
the forming fluidized particles step further comprising wherein the fluidized particles are comprised of iron,
the forming fluidized particles step further comprising wherein the fluidizing medium is comprised of gas containing 1,1-dichloroethane or iron pentacarbonyl, and
the applying a building agent step further comprising applying either ultraviolet radiation or infrared radiation wherein ultraviolet radiation is applied when the fluidizing gas contains 1,1-dichloroethane or infrared radiation is applied when the fluidizing gas contains iron pentacarbonyl.

7. The method of claim 1 further comprising wherein,
the fluidized particles are comprised of droplets of a polar resin,
the fluidizing medium is comprised of a non-polar substance.

8. The method of claim 1 further comprising wherein,
the forming fluidized particles step further comprising wherein the fluidized particles are comprised of silicon dioxide or a mixture of a metal and a non-metal oxide,
the forming fluidized particles step further comprising wherein the fluidizing medium is comprised of an inert gas,
the applying a building agent step further comprising applying a flame, wherein an oxide glass is formed.

9. The method of claim 1 further comprising wherein,
the forming fluidized particles step further comprising wherein the fluidized particles are comprised of a metal and metal oxide,
the forming fluidized particles step further comprising wherein the fluidizing medium is comprised of hydrogen gas or a mixture of hydrogen gas and an inert gas,
the applying a building agent step further comprising applying a flame, thereby forming an alloy.

10. The method of claim 1 further comprising wherein,
the fluidizing force is applied by vibrations or sound waves.

11. The method of claim 1 further comprising wherein,
the fluidizing force is applied by an electric charge.

12. The method of claim 1 further comprising wherein, said building said three dimensional objects is performed by incorporating pre-formed solid objects, said pre-formed and anchored solid objects being anchored in said fluidized bed.

13. The method of claim 1, wherein said three dimensional objects are created de novo.

14. The method of claim 13 further comprising wherein,
the forming fluidized particles step further comprising wherein the fluidized particles are comprised of a thermoplastic material or the fluidized particles are comprised of a non-thermoplastic material, wherein the non-thermoplastic material being coated with a thermoplastic material,
the forming fluidized particles step further comprising wherein the fluidizing medium is comprised of an inert gas, and
the applying a building agent step further comprising applying of infrared radiation.

15. The method of claim 13 further comprising wherein,
the forming fluidized particles step further comprising wherein the fluidized particles are comprised of a plastic resin or the fluidized particles having a plastic resin coating,
the forming fluidized particles step further comprising wherein the fluidizing medium is comprised of an inert gas, and
the applying a building agent step further comprising applying of ultraviolet radiation.

16. The method of claim 13 further comprising wherein,
the forming fluidized particles step further comprising wherein the fluidized particles are comprised of a plastic material,
the forming fluidized particles step further comprising wherein the fluidizing medium is comprised of a gas, and
the applying a building agent step further comprising applying of an adhesive.

17. The method of claim 13 further comprising wherein,
the forming fluidized particles step further comprising wherein the fluidized particles are comprised of a metal or a metal alloy,
the forming fluidized particles step further comprising wherein the fluidizing medium is comprised of an inert gas, and
the applying a building agent step further comprising wherein the building agent is,
(a) a plasma arc, or
(b) an electric arc, or
(c) oxy-fuel welding, or
(d) a laser.

18. The method of claim 13 further comprising wherein,
the forming fluidized particles step further comprising wherein the fluidized particles are comprised of iron,
the forming fluidized particles step further comprising wherein the fluidizing medium is comprised of gas containing 1,1-dichloroethane or iron pentacarbonyl, and
the applying a building agent step further comprising applying either ultraviolet radiation or infrared radiation wherein ultraviolet radiation is applied when the fluidizing gas contains 1,1-dichloroethane or infrared radiation is applied when the fluidizing gas contains iron pentacarbonyl.

19. The method of claim 13 further comprising wherein,
the fluidizing force is applied by vibrations or sound waves.

20. The method of claim 13 further comprising wherein,
the fluidizing force is applied by an electric charge.
